(19) United States
(12) Patent Application Publication
(10) Pub. No.: US 2026/0343030 A1
(43) Pub. Date: Oct. 29, 2026

(54) IMAGE ENCODING/DECODING METHOD AND DEVICE, AND RECORDING MEDIUM ON WHICH BITSTREAM IS STORED

(71) Applicant: LG ELECTRONICS INC., Seoul (KR)

(72) Inventors: Jangwon LEE, Seoul (KR); Hendry TAN, San Diego, CA (US); Chulkeun KIM, Seoul (KR); Jaehyun LIM, Seoul (KR); Junghak NAM, Seoul (KR); Seunghwan KIM, San Diego, CA (US)

(73) Assignee: LG ELECTRONICS INC., Seoul (KR)

(21) Appl. No.: 19/678,542

(22) Filed: May 15, 2026

Related U.S. Application Data
(63) Continuation of application No. PCT/KR2026/000113, filed on Jan. 2, 2026.
(60) Provisional application No. 63/741,463, filed on Jan. 3, 2025.
(60) Provisional application No. 63/747,058, filed on Jan. 19, 2025.

(51) Int. Cl. H04N 19/70

(52) U.S. Cl. CPC H04N 19/70

(57) ABSTRACT

An image decoding method and apparatus according to the present disclosure may receive a bitstream including an encoded video picture and reconstruct the encoded video picture included in the bitstream. Here, the bitstream may include a digitally signed content SEI message. The digitally signed content SEI message may include at least one of a digitally signed content initialization SEI message, a digitally signed content selection SEI message or a digitally signed content verification SEI message.

### CROSS-REFERENCE TO RELATED APPLICATIONS

This application is a continuation of International Application No. PCT/KR2026/000113, filed on Jan. 2, 2026, which claims the benefit of earlier filing date and right of priority to U.S. Provisional Application No. 63/741,463, filed on Jan. 3, 2025, and 63/747,058, filed on Jan. 19, 2025, the contents of which are all incorporated by reference herein in their entireties.

### TECHNICAL FIELD

The present disclosure relates to an image encoding/decoding method and apparatus, and a recording medium storing a bitstream.

### BACKGROUND

Recently, the demand for high-resolution and high-quality images such as HD (High Definition) images and UHD (Ultra High Definition) images has been increasing in various application fields, and accordingly, highly efficient image compression technologies are being discussed.

There are a variety of technologies such as inter-prediction technology that predicts a pixel value included in a current picture from a picture before or after a current picture with video compression technology, intra-prediction technology that predicts a pixel value included in a current picture by using pixel information in a current picture, entropy coding technology that allocates a short sign to a value with high appearance frequency and a long sign to a value with low appearance frequency, etc. and these image compression technologies may be used to effectively compress image data and transmit or store it.

### SUMMARY

The present disclosure provides a method and an apparatus for configuring a DSC SEI message.

The present disclosure provides a method and an apparatus for signaling a DSC SEI message.

An image decoding method and apparatus according to the present disclosure may receive a bitstream including an encoded video picture and reconstruct the encoded video picture included in the bitstream. The bitstream may include a digitally signed content (DSC) supplemental enhancement information (SEI) message. The DSC SEI message may include at least one of a digitally signed content initialization (DSCI) SEI message, a digitally signed content selection (DSCS) SEI message or a digitally signed content verification (DSCV) SEI message. The DSC SEI message may be obtained from a network abstraction layer (NAL) unit of the bitstream.

In an image decoding method and apparatus according to the present disclosure, when two or more DSCI SEI messages exist in one access unit (AU), all DSCI SEI messages belonging to the one AU may be restricted to have the same content.

In an image decoding method and apparatus according to the present disclosure, the maximum number of the DSCI SEI messages that can be included in one access unit (AU) may be restricted to 1.

In an image decoding method and apparatus according to the present disclosure, the DSCI SEI message may be restricted to exist for a coded video sequence start (CVSS) access unit (AU) within a coded video sequence (CVS).

In an image decoding method and apparatus according to the present disclosure, all DSCI SEI messages applied to the same coded video sequence (CVS) may be restricted to have the same content.

In an image decoding method and apparatus according to the present disclosure, when the DSCI SEI message exists in an access unit (AU) within a coded video sequence (CVS), the DSCV SEI message may be restricted to exist within the CVS for each substream to which the NAL unit is assigned.

In an image decoding method and apparatus according to the present disclosure, a persistence scope of the DSCI SEI message may be specified by semantics of the DSCI SEI message.

In an image decoding method and apparatus according to the present disclosure, a persistence scope of the DSCI SEI message may be a coded video sequence (CVS) including the DSCI SEI message.

In an image decoding method and apparatus according to the present disclosure, all DSCI SEI messages existing in an access unit (AU) other than an instantaneous random access point (IRAP) AU or a gradual decoder refresh (GDR) AU may be restricted to have the same content as a DSCI SEI message existing in the last IRAP AU or the last GDR AU.

In an image decoding method and apparatus according to the present disclosure, all DSCI SEI messages existing in a picture unit (PU) other than an instantaneous random access point (IRAP) PU or a gradual decoder refresh (GDR) PU may be restricted to have the same content as a DSCI SEI message existing in the last IRAP PU or the last GDR PU.

In an image decoding method and apparatus according to the present disclosure, a DSCI SEI message having a DSCI identifier of a specific value may be restricted such that at most one is included in one access unit (AU).

In an image decoding method and apparatus according to the present disclosure, the DSCV SEI message may include a substream identifier representing a verification substream to which the DSCV SEI message is applied. The first DSCV SEI message having a specific DSCV identifier that follows a DSCI SEI message having a DSCI identifier of the same value as the specific DSCV identifier in decoding order may be restricted to have a substream identifier with a value of 0.

An image encoding method and apparatus according to the present disclosure may receive a video picture to be encoded, encode the received video picture to generate video information related to the video picture, generate a digitally signed content (DSC) supplemental enhancement information (SEI) message and generate a bitstream including the video information and the DSC SEI message. The DSC SEI message may include at least one of a digitally signed content initialization (DSCI) SEI message, a digitally signed content selection (DSCS) SEI message or a digitally signed content verification (DSCV) SEI message. The DSC SEI message may be encoded into a network abstraction layer (NAL) unit of the bitstream.

A computer-readable digital storage medium storing encoded video/image information that causes performing the image decoding method by a decoding apparatus according to the present disclosure is provided.

A computer-readable digital storage medium storing video/image information generated according to the image encoding method according to the present disclosure is provided.

A method and an apparatus for transmitting video/image information generated according to an image encoding method according to the present disclosure are provided.

According to the present disclosure, the number of DSC SEI messages that may exist within an AU may be clarified and a method for processing a case in which multiple DSCI SEI messages exist may be clarified.

According to the present disclosure, the value of dscv_verification_substream_id of the first DSCV SEI message after a DSCI SEI message may be clarified.

### BRIEF DESCRIPTION OF THE DRAWINGS

FIG. 1 shows a video/image coding system according to the present disclosure.

FIG. 2 shows a schematic block diagram of an encoding apparatus to which an embodiment of the present disclosure is applicable and encoding of video/image signals is performed.

FIG. 3 shows a schematic block diagram of a decoding apparatus to which an embodiment of the present disclosure is applicable and decoding of video/image signals is performed.

FIG. 4 illustrates a method for reconstructing a video picture performed by the decoding apparatus 300 according to the present disclosure.

FIG. 5 illustrates a schematic configuration of the decoding apparatus 300 that performs a method for reconstructing a video picture according to the present disclosure.

FIG. 6 illustrates a method for generating a bitstream performed by the encoding apparatus 200 according to the present disclosure.

FIG. 7 illustrates a schematic configuration of the encoding apparatus 200 that performs a method for generating a bitstream according to the present disclosure.

FIG. 8 shows an example of a contents streaming system to which embodiments of the present disclosure may be applied.

### DETAILED DESCRIPTION

Since the present disclosure may make various changes and have several embodiments, specific embodiments will be illustrated in a drawing and described in detail in a detailed description. However, it is not intended to limit the present disclosure to a specific embodiment, and should be understood to include all changes, equivalents and substitutes included in the spirit and technical scope of the present disclosure. While describing each drawing, similar reference numerals are used for similar components.

A term such as first, second, etc. may be used to describe various components, but the components should not be limited by the terms. The terms are used only to distinguish one component from other components. For example, the first component may be referred to as the second component without departing from the scope of a right of the present disclosure, and similarly, the second component may also be referred to as the first component. A term of and/or includes any of a plurality of related stated items or a combination of a plurality of related stated items.

When a component is referred to as “being connected” or “being linked” to another component, it should be understood that it may be directly connected or linked to another component, but another component may exist in the middle. On the other hand, when a component is referred to as “being directly connected” or “being directly linked” to another component, it should be understood that there is no another component in the middle.

A term used in this application is just used to describe a specific embodiment, and is not intended to limit the present disclosure. Singular expressions include plural expressions unless the context clearly dictates otherwise. In this application, it should be understood that a term such as “include” or “have”, etc. is intended to designate the presence of features, numbers, steps, operations, components, parts or combinations thereof described in the specification, but does not exclude in advance the possibility of presence or addition of one or more other features, numbers, steps, operations, components, parts or combinations thereof.

The present disclosure relates to video/image coding. For example, a method/an embodiment disclosed herein may be applied to a method disclosed in the versatile video coding (VVC) standard. In addition, a method/an embodiment disclosed herein may be applied to a method disclosed in the essential video coding (EVC) standard, the AOMedia Video 1 (AV1) standard, the 2nd generation of audio video coding standard (AVS2) or the next-generation video/image coding standard (ex.H.267 or H.268, etc.).

This specification proposes various embodiments of video/image coding, and unless otherwise specified, the embodiments may be performed in combination with each other.

Herein, a video may refer to a set of a series of images over time. A picture generally refers to a unit representing one image in a specific time period, and a slice/a tile is a unit that forms part of a picture in coding. A slice/a tile may include at least one coding tree unit (CTU). One picture may consist of at least one slice/tile. One tile is a rectangular area composed of a plurality of CTUs within a specific tile column and a specific tile row of one picture. A tile column is a rectangular area of CTUs having the same height as that of a picture and a width designated by a syntax requirement of a picture parameter set. A tile row is a rectangular area of CTUs having a height designated by a picture parameter set and the same width as that of a picture. CTUs within one tile may be arranged consecutively according to CTU raster scan, while tiles within one picture may be arranged consecutively according to raster scan of a tile. One slice may include an integer number of complete tiles or an integer number of consecutive complete CTU rows within a tile of a picture that may be included exclusively in a single NAL unit. Meanwhile, one picture may be divided into at least two sub-pictures. A sub-picture may be a rectangular area of at least one slice within a picture.

A pixel, a pixel or a pel may refer to the minimum unit that constitutes one picture (or image). In addition, ‘sample’ may be used as a term corresponding to a pixel. A sample may generally represent a pixel or a pixel value, and may represent only a pixel/a pixel value of a luma component, or only a pixel/a pixel value of a chroma component.

A unit may represent a basic unit of image processing. A unit may include at least one of a specific area of a picture and information related to a corresponding area. One unit may include one luma block and two chroma (ex. cb, cr) blocks. In some cases, a unit may be used interchangeably with a term such as a block or an area, etc. In a general case, a M×N block may include a set (or an array) of transform coefficients or samples (or sample arrays) consisting of M columns and N rows.

Herein, “A or B” may refer to “only A”, “only B” or “both A and B.” In other words, herein, “A or B” may be interpreted as “A and/or B.” For example, herein, “A, B or C” may refer to “only A”, “only B”, “only C” or “any combination of A, B and C)”.

A slash (/) or a comma used herein may refer to “and/or.” For example, “A/B” may refer to “A and/or B.” Accordingly, “A/B” may refer to “only A”, “only B” or “both A and B.” For example, “A, B, C” may refer to “A, B, or C”.

Herein, “at least one of A and B” may refer to “only A”, “only B” or “both A and B”. In addition, herein, an expression such as “at least one of A or B” or “at least one of A and/or B” may be interpreted in the same way as “at least one of A and B”.

In addition, herein, “at least one of A, B and C” may refer to “only A”, “only B”, “only C”, or “any combination of A, B and C”. In addition, “at least one of A, B or C” or “at least one of A, B and/or C” may refer to “at least one of A, B and C”.

In addition, a parenthesis used herein may refer to “for example.” Specifically, when indicated as “prediction (intra prediction)”, “intra prediction” may be proposed as an example of “prediction”. In other words, “prediction” herein is not limited to “intra prediction” and “intra prediction” may be proposed as an example of “prediction.” In addition, even when indicated as “prediction (i.e., intra prediction)”, “intra prediction” may be proposed as an example of “prediction.”

Herein, a technical feature described individually in one drawing may be implemented individually or simultaneously.

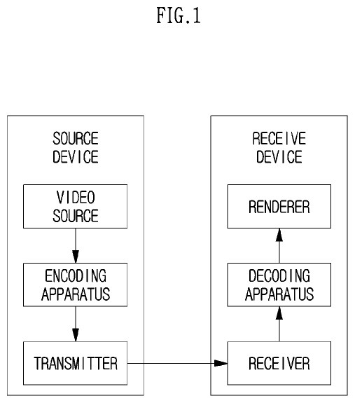

FIG. 1 shows a video/image coding system according to the present disclosure.

Referring to FIG. 1, a video/image coding system may include the first device (a source device) and the second device (a receiving device).

A source device may transmit encoded video/image information or data in a form of a file or streaming to a receiving device through a digital storage medium or a network. The source device may include a video source, an encoding apparatus and a transmission unit. The receiving device may include a reception unit, a decoding apparatus and a renderer. The encoding apparatus may be referred to as a video/image encoding apparatus and the decoding apparatus may be referred to as a video/image decoding apparatus. A transmitter may be included in an encoding apparatus. A receiver may be included in a decoding apparatus. A renderer may include a display unit, and a display unit may be composed of a separate device or an external component.

A video source may acquire a video/an image through a process of capturing, synthesizing or generating a video/an image. A video source may include a device of capturing a video/an image and a device of generating a video/an image. A device of capturing a video/an image may include at least one camera, a video/image archive including previously captured videos/images, etc. A device of generating a video/an image may include a computer, a tablet, a smartphone, etc. and may (electronically) generate a video/an image. For example, a virtual video/image may be generated through a computer, etc., and in this case, a process of capturing a video/an image may be replaced by a process of generating related data.

An encoding apparatus may encode an input video/image. An encoding apparatus may perform a series of procedures such as prediction, transform, quantization, etc. for compression and coding efficiency. Encoded data (encoded video/image information) may be output in a form of a bitstream.

A transmission unit may transmit encoded video/image information or data output in a form of a bitstream to a reception unit of a receiving device through a digital storage medium or a network in a form of a file or streaming. A digital storage medium may include various storage media such as USB, SD, CD, DVD, Blu-ray, HDD, SSD, etc. A transmission unit may include an element for generating a media file through a predetermined file format and may include an element for transmission through a broadcasting/communication network. A reception unit may receive/extract the bitstream and transmit it to a decoding apparatus.

A decoding apparatus may decode a video/an image by performing a series of procedures such as dequantization, inverse transform, prediction, etc. corresponding to an operation of an encoding apparatus.

A renderer may render a decoded video/image. A rendered video/image may be displayed through a display unit.

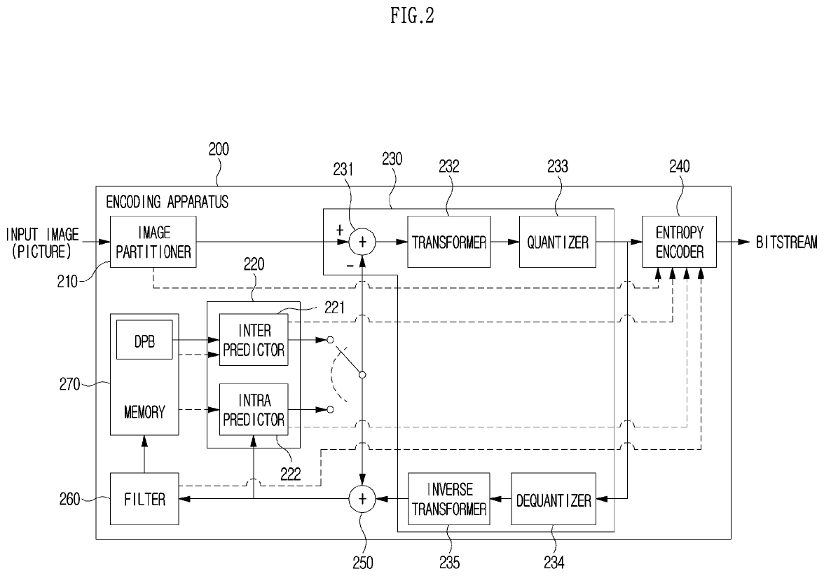

FIG. 2 shows a rough block diagram of an encoding apparatus to which an embodiment of the present disclosure may be applied and encoding of a video/image signal is performed.

Referring to FIG. 2, an encoding apparatus 200 may be composed of an image partitioner 210, a predictor 220, a residual processor 230, an entropy encoder 240, an adder 250, a filter 260 and a memory 270. A predictor 220 may include an inter predictor 221 and an intra predictor 222. A residual processor 230 may include a transformer 232, a quantizer 233, a dequantizer 234 and an inverse transformer 235. A residual processor 230 may further include a subtractor 231. An adder 250 may be referred to as a reconstructor or a reconstructed block generator. The above-described image partitioner 210, predictor 220, residual processor 230, entropy encoder 240, adder 250 and filter 260 may be configured by at least one hardware component (e.g., an encoder chipset or a processor) according to an embodiment. In addition, a memory 270 may include a decoded picture buffer (DPB) and may be configured by a digital storage medium. The hardware component may further include a memory 270 as an internal/external component.

An image partitioner 210 may partition an input image (or picture, frame) input to an encoding apparatus 200 into at least one processing unit. As an example, the processing unit may be referred to as a coding unit (CU). In this case, a coding unit may be partitioned recursively according to a quad-tree binary-tree ternary-tree (QTBTTT) structure from a coding tree unit (CTU) or the largest coding unit (LCU).

For example, one coding unit may be partitioned into a plurality of coding units with a deeper depth based on a quad tree structure, a binary tree structure and/or a ternary structure. In this case, for example, a quad tree structure may be applied first and a binary tree structure and/or a ternary structure may be applied later. Alternatively, a binary tree structure may be applied before a quad tree structure. A coding procedure according to this specification may be performed based on a final coding unit that is no longer partitioned. In this case, based on coding efficiency, etc. according to an image characteristic, the largest coding unit may be directly used as a final coding unit, or if necessary, a coding unit may be recursively partitioned into coding units of a deeper depth, and a coding unit with an optimal size may be used as a final coding unit. Here, a coding procedure may include a procedure such as prediction, transform, and reconstruction, etc. described later.

As another example, the processing unit may further include a prediction unit (PU) or a transform unit (TU). In this case, the prediction unit and the transform unit may be divided or partitioned from a final coding unit described above, respectively. The prediction unit may be a unit of sample prediction, and the transform unit may be a unit for deriving a transform coefficient and/or a unit for deriving a residual signal from a transform coefficient.

In some cases, a unit may be used interchangeably with a term such as a block or an area, etc. In a general case, a M×N block may represent a set of transform coefficients or samples consisting of M columns and N rows. A sample may generally represent a pixel or a pixel value, and may represent only a pixel/a pixel value of a luma component, or only a pixel/a pixel value of a chroma component. A sample may be used as a term that makes one picture (or image) correspond to a pixel or a pel.

An encoding apparatus 200 may subtract a prediction signal (a prediction block, a prediction sample array) output from an inter predictor 221 or an intra predictor 222 from an input image signal (an original block, an original sample array) to generate a residual signal (a residual signal, a residual sample array), and a generated residual signal is transmitted to a transformer 232. In this case, a unit that subtracts a prediction signal (a prediction block, a prediction sample array) from an input image signal (an original block, an original sample array) within an encoding apparatus 200 may be referred to as a subtractor 231.

A predictor 220 may perform prediction on a block to be processed (hereinafter, referred to as a current block) and generate a predicted block including prediction samples for the current block. A predictor 220 may determine whether intra prediction or inter prediction is applied in a unit of a current block or a CU. A predictor 220 may generate various information on prediction such as prediction mode information, etc. and transmit it to an entropy encoder 240 as described later in a description of each prediction mode. Information on prediction may be encoded in an entropy encoder 240 and output in a form of a bitstream.

An intra predictor 222 may predict a current block by referring to samples within a current picture. The samples referred to may be positioned in the neighborhood of the current block or may be positioned a certain distance away from the current block according to a prediction mode. In intra prediction, prediction modes may include at least one nondirectional mode and a plurality of directional modes. A nondirectional mode may include at least one of a DC mode or a planar mode. A directional mode may include 33 directional modes or 65 directional modes according to a detail level of a prediction direction. However, it is an example, and more or less directional modes may be used according to a configuration. An intra predictor 222 may determine a prediction mode applied to a current block by using a prediction mode applied to a neighboring block.

An inter predictor 221 may derive a prediction block for a current block based on a reference block (a reference sample array) specified by a motion vector on a reference picture. In this case, in order to reduce the amount of motion information transmitted in an inter prediction mode, motion information may be predicted in a unit of a block, a sub-block or a sample based on the correlation of motion information between a neighboring block and a current block. The motion information may include a motion vector and a reference picture index. The motion information may further include inter prediction direction information (L0 prediction, L1 prediction, Bi prediction, etc.). For inter prediction, a neighboring block may include a spatial neighboring block existing in a current picture and a temporal neighboring block existing in a reference picture. A reference picture including the reference block and a reference picture including the temporal neighboring block may be the same or different. The temporal neighboring block may be referred to as a collocated reference block, a collocated CU (colCU), etc., and a reference picture including the temporal neighboring block may be referred to as a collocated picture (colPic). For example, an inter predictor 221 may configure a motion information candidate list based on neighboring blocks and generate information indicating which candidate is used to derive a motion vector and/or a reference picture index of the current block. Inter prediction may be performed based on various prediction modes, and for example, for a skip mode and a merge mode, an inter predictor 221 may use motion information of a neighboring block as motion information of a current block. For a skip mode, unlike a merge mode, a residual signal may not be transmitted. For a motion vector prediction (MVP) mode, a motion vector of a neighboring block is used as a motion vector predictor and a motion vector difference is signaled to indicate a motion vector of a current block.

A predictor 220 may generate a prediction signal based on various prediction methods described later. For example, a predictor may not only apply intra prediction or inter prediction for prediction for one block, but also may apply intra prediction and inter prediction simultaneously. It may be referred to as a combined inter and intra prediction (CIIP) mode. In addition, a predictor may be based on an intra block copy (IBC) prediction mode or may be based on a palette mode for prediction for a block. The IBC prediction mode or palette mode may be used for content image/video coding of a game, etc. such as screen content coding (SCC), etc. IBC basically performs prediction within a current picture, but it may be performed similarly to inter prediction in that it derives a reference block within a current picture. In other words, IBC may use at least one of inter prediction techniques described herein. A palette mode may be considered as an example of intra coding or intra prediction. When a palette mode is applied, a sample value within a picture may be signaled based on information on a palette table and a palette index. A prediction signal generated through the predictor 220 may be used to generate a reconstructed signal or a residual signal.

A transformer 232 may generate transform coefficients by applying a transform technique to a residual signal. For example, a transform technique may include at least one of Discrete Cosine Transform (DCT), Discrete Sine Transform (DST), Karhunen-Loève Transform (KLT), Graph-Based Transform (GBT) or Conditionally Non-linear Transform (CNT). Here, GBT refers to transform obtained from this graph when relationship information between pixels is expressed as a graph. CNT refers to transform obtained based on generating a prediction signal by using all previously reconstructed pixels. In addition, a transform process may be applied to a square pixel block in the same size or may be applied to a non-square block in a variable size.

A quantizer 233 may quantize transform coefficients and transmit them to an entropy encoder 240 and an entropy encoder 240 may encode a quantized signal (information on quantized transform coefficients) and output it as a bitstream. Information on the quantized transform coefficients may be referred to as residual information. A quantizer 233 may reorder quantized transform coefficients in a block form into a 1D vector form based on coefficient scan order, and may generate information on the quantized transform coefficients based on the quantized transform coefficients in the 1D vector form.

An entropy encoder 240 may perform various encoding methods such as exponential Golomb, context-adaptive variable length coding (CAVLC), context-adaptive binary arithmetic coding (CABAC), etc. An entropy encoder 240 may encode information necessary for video/image reconstruction (e.g., a value of syntax elements, etc.) other than quantized transform coefficients together or separately.

Encoded information (ex. encoded video/image information) may be transmitted or stored in a unit of a network abstraction layer (NAL) unit in a bitstream form. The video/image information may further include information on various parameter sets such as an adaptation parameter set (APS), a picture parameter set (PPS), a sequence parameter set (SPS) or a video parameter set (VPS), etc. In addition, the video/image information may further include general constraint information. Herein, information and/or syntax elements transmitted/signaled from an encoding apparatus to a decoding apparatus may be included in video/image information. The video/image information may be encoded through the above-described encoding procedure and included in the bitstream. The bitstream may be transmitted through a network or may be stored in a digital storage medium. Here, a network may include a broadcasting network and/or a communication network, etc. and a digital storage medium may include various storage media such as USB, SD, CD, DVD, Blu-ray, HDD, SSD, etc. A transmission unit (not shown) for transmitting and/or a storage unit (not shown) for storing a signal output from an entropy encoder 240 may be configured as an internal/external element of an encoding apparatus 200, or a transmission unit may be also included in an entropy encoder 240.

Quantized transform coefficients output from a quantizer 233 may be used to generate a prediction signal. For example, a residual signal (a residual block or residual samples) may be reconstructed by applying dequantization and inverse transform to quantized transform coefficients through a dequantizer 234 and an inverse transformer 235. An adder 250 may add a reconstructed residual signal to a prediction signal output from an inter predictor 221 or an intra predictor 222 to generate a reconstructed signal (a reconstructed picture, a reconstructed block, a reconstructed sample array). When there is no residual for a block to be processed like when a skip mode is applied, a predicted block may be used as a reconstructed block. An adder 250 may be referred to as a reconstructor or a reconstructed block generator. A generated reconstructed signal may be used for intra prediction of a next block to be processed within a current picture, and may be also used for inter prediction of a next picture through filtering as described later. Meanwhile, luma mapping with chroma scaling (LMCS) may be applied in a picture encoding and/or reconstruction process.

A filter 260 may improve subjective/objective image quality by applying filtering to a reconstructed signal. For example, a filter 260 may generate a modified reconstructed picture by applying various filtering methods to a reconstructed picture, and may store the modified reconstructed picture in a memory 270, specifically in a DPB of a memory 270. The various filtering methods may include deblocking filtering, sample adaptive offset, adaptive loop filter, bilateral filter, etc. A filter 260 may generate various information on filtering and transmit it to an entropy encoder 240. Information on filtering may be encoded in an entropy encoder 240 and output in a form of a bitstream.

A modified reconstructed picture transmitted to a memory 270 may be used as a reference picture in an inter predictor 221. When inter prediction is applied through it, an encoding apparatus may avoid prediction mismatch in an encoding apparatus 200 and a decoding apparatus, and may also improve encoding efficiency.

A DPB of a memory 270 may store a modified reconstructed picture to use it as a reference picture in an inter predictor 221. A memory 270 may store motion information of a block from which motion information in a current picture is derived (or encoded) and/or motion information of blocks in a pre-reconstructed picture. The stored motion information may be transmitted to an inter predictor 221 to be used as motion information of a spatial neighboring block or motion information of a temporal neighboring block. A memory 270 may store reconstructed samples of reconstructed blocks in a current picture and transmit them to an intra predictor 222.

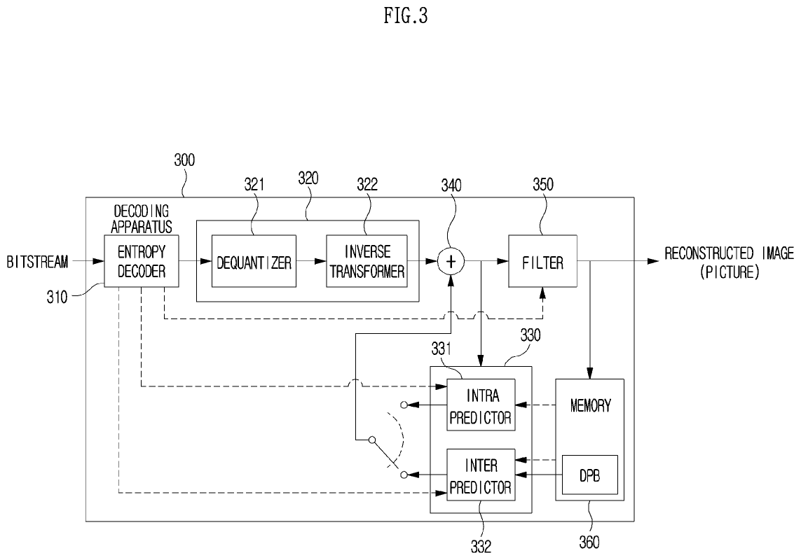

FIG. 3 shows a rough block diagram of a decoding apparatus to which an embodiment of the present disclosure may be applied and decoding of a video/image signal is performed.

Referring to FIG. 3, a decoding apparatus 300 may be configured by including an entropy decoder 310, a residual processor 320, a predictor 330, an adder 340, a filter 350 and a memory 360. A predictor 330 may include an inter predictor 332 and an intra predictor 331. A residual processor 320 may include a dequantizer 321 and an inverse transformer 321.

According to an embodiment, the above-described entropy decoder 310, residual processor 320, predictor 330, adder 340 and filter 350 may be configured by one hardware component (e.g., a decoder chipset or a processor). In addition, a memory 360 may include a decoded picture buffer (DPB) and may be configured by a digital storage medium. The hardware component may further include a memory 360 as an internal/external component.

When a bitstream including video/image information is input, a decoding apparatus 300 may reconstruct an image in response to a process in which video/image information is processed in an encoding apparatus of FIG. 2. For example, a decoding apparatus 300 may derive units/blocks based on block partition-related information obtained from the bitstream. A decoding apparatus 300 may perform decoding by using a processing unit applied in an encoding apparatus. Accordingly, a processing unit of decoding may be a coding unit, and a coding unit may be partitioned from a coding tree unit or the largest coding unit according to a quad tree structure, a binary tree structure and/or a ternary tree structure. At least one transform unit may be derived from a coding unit. And, a reconstructed image signal decoded and output through a decoding apparatus 300 may be played through a playback device.

A decoding apparatus 300 may receive a signal output from an encoding apparatus of FIG. 2 in a form of a bitstream, and a received signal may be decoded through an entropy decoder 310. For example, an entropy decoder 310 may parse the bitstream to derive information (ex. video/image information) necessary for image reconstruction (or picture reconstruction). The video/image information may further include information on various parameter sets such as an adaptation parameter set (APS), a picture parameter set (PPS), a sequence parameter set (SPS) or a video parameter set (VPS), etc. In addition, the video/image information may further include general constraint information. A decoding apparatus may decode a picture further based on information on the parameter set and/or the general constraint information. Signaled/received information and/or syntax elements described later herein may be decoded through the decoding procedure and obtained from the bitstream. For example, an entropy decoder 310 may decode information in a bitstream based on a coding method such as exponential Golomb encoding, CAVLC, CABAC, etc. and output a value of a syntax element necessary for image reconstruction and quantized values of a transform coefficient regarding a residual. In more detail, a CABAC entropy decoding method may receive a bin corresponding to each syntax element from a bitstream, determine a context model by using syntax element information to be decoded, decoding information of a neighboring block and a block to be decoded or information of a symbol/a bin decoded in a previous step, perform arithmetic decoding of a bin by predicting a probability of occurrence of a bin according to a determined context model and generate a symbol corresponding to a value of each syntax element. In this case, a CABAC entropy decoding method may update a context model by using information on a decoded symbol/bin for a context model of a next symbol/bin after determining a context model. Among information decoded in an entropy decoder 310, information on prediction is provided to a predictor (an inter predictor 332 and an intra predictor 331), and a residual value on which entropy decoding was performed in an entropy decoder 310, i.e., quantized transform coefficients and related parameter information may be input to a residual processor 320. A residual processor 320 may derive a residual signal (a residual block, residual samples, a residual sample array). In addition, information on filtering among information decoded in an entropy decoder 310 may be provided to a filter 350. Meanwhile, a reception unit (not shown) that receives a signal output from an encoding apparatus may be further configured as an internal/external element of a decoding apparatus 300 or a reception unit may be a component of an entropy decoder 310.

Meanwhile, a decoding apparatus according to this specification may be referred to as a video/image/picture decoding apparatus, and the decoding apparatus may be divided into an information decoder (a video/image/picture information decoder) and a sample decoder (a video/image/picture sample decoder). The information decoder may include the entropy decoder 310 and the sample decoder may include at least one of dequantizer 321, the inverse transformer 322, the adder 340, the filter 350, the memory 360, the inter predictor 332 and the intra predictor 331.

A dequantizer 321 may dequantize quantized transform coefficients and output transform coefficients. A dequantizer 321 may reorder quantized transform coefficients into a two-dimensional block form. In this case, the reordering may be performed based on coefficient scan order performed in an encoding apparatus. A dequantizer 321 may perform dequantization on quantized transform coefficients by using a quantization parameter (e.g., quantization step size information) and obtain transform coefficients.

An inverse transformer 322 inversely transforms transform coefficients to obtain a residual signal (a residual block, a residual sample array).

A predictor 320 may perform prediction on a current block and generate a predicted block including prediction samples for the current block. A predictor 320 may determine whether intra prediction or inter prediction is applied to the current block based on the information on prediction output from an entropy decoder 310 and determine a specific intra/inter prediction mode.

A predictor 320 may generate a prediction signal based on various prediction methods described later. For example, a predictor 320 may not only apply intra prediction or inter prediction for prediction for one block, but also may apply intra prediction and inter prediction simultaneously. It may be referred to as a combined inter and intra prediction (CIIP) mode. In addition, a predictor may be based on an intra block copy (IBC) prediction mode or may be based on a palette mode for prediction for a block. The IBC prediction mode or palette mode may be used for content image/video coding of a game, etc. such as screen content coding (SCC), etc. IBC basically performs prediction within a current picture, but it may be performed similarly to inter prediction in that it derives a reference block within a current picture. In other words, IBC may use at least one of inter prediction techniques described herein. A palette mode may be considered as an example of intra coding or intra prediction. When a palette mode is applied, information on a palette table and a palette index may be included in the video/image information and signaled.

An intra predictor 331 may predict a current block by referring to samples within a current picture. The samples referred to may be positioned in the neighborhood of the current block or may be positioned a certain distance away from the current block according to a prediction mode. In intra prediction, prediction modes may include at least one nondirectional mode and a plurality of directional modes. An intra predictor 331 may determine a prediction mode applied to a current block by using a prediction mode applied to a neighboring block.

An inter predictor 332 may derive a prediction block for a current block based on a reference block (a reference sample array) specified by a motion vector on a reference picture. In this case, in order to reduce the amount of motion information transmitted in an inter prediction mode, motion information may be predicted in a unit of a block, a sub-block or a sample based on the correlation of motion information between a neighboring block and a current block. The motion information may include a motion vector and a reference picture index. The motion information may further include inter prediction direction information (L0 prediction, L1 prediction, Bi prediction, etc.). For inter prediction, a neighboring block may include a spatial neighboring block existing in a current picture and a temporal neighboring block existing in a reference picture. For example, an inter predictor 332 may configure a motion information candidate list based on neighboring blocks and derive a motion vector and/or a reference picture index of the current block based on received candidate selection information. Inter prediction may be performed based on various prediction modes, and the information on prediction may include information indicating an inter prediction mode for the current block.

An adder 340 may add an obtained residual signal to a prediction signal (a prediction block, a prediction sample array) output from a predictor (including an inter predictor 332 and/or an intra predictor 331) to generate a reconstructed signal (a reconstructed picture, a reconstructed block, a reconstructed sample array). When there is no residual for a block to be processed like when a skip mode is applied, a prediction block may be used as a reconstructed block.

An adder 340 may be referred to as a reconstructor or a reconstructed block generator. A generated reconstructed signal may be used for intra prediction of a next block to be processed in a current picture, may be output through filtering as described later or may be used for inter prediction of a next picture. Meanwhile, luma mapping with chroma scaling (LMCS) may be applied in a picture decoding process.

A filter 350 may improve subjective/objective image quality by applying filtering to a reconstructed signal. For example, a filter 350 may generate a modified reconstructed picture by applying various filtering methods to a reconstructed picture and transmit the modified reconstructed picture to a memory 360, specifically a DPB of a memory 360. The various filtering methods may include deblocking filtering, sample adaptive offset, adaptive loop filter, bilateral filter, etc.

The (modified) reconstructed picture stored in the DPB of the memory 360 can be used as a reference picture in the inter predictor 332. A memory 360 may store motion information of a block from which motion information in a current picture is derived (or decoded) and/or motion information of blocks in a pre-reconstructed picture. The stored motion information may be transmitted to an inter predictor 332 to be used as motion information of a spatial neighboring block or motion information of a temporal neighboring block. A memory 360 may store reconstructed samples of reconstructed blocks in a current picture and transmit them to an intra predictor 331.

Herein, embodiments described in a filter 260, an inter predictor 221 and an intra predictor 222 of an encoding apparatus 200 may be also applied equally or correspondingly to a filter 350, an inter predictor 332 and an intra predictor 331 of a decoding apparatus 300, respectively.

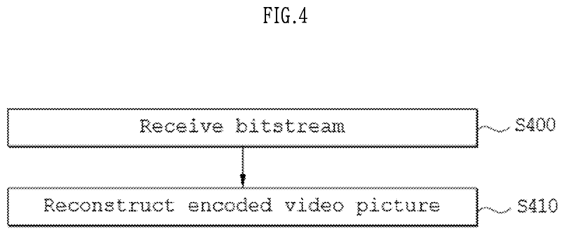

FIG. 4 illustrates a method for reconstructing a video picture performed by the decoding apparatus 300 according to the present disclosure.

A bitstream including an encoded video picture may be received S400.

The encoded video picture of a bitstream may be reconstructed S410.

Video information related to an encoded video picture may be extracted from a bitstream. An encoded video picture may be reconstructed based on extracted video information.

A bitstream may include a digitally signed content (DSC) supplemental enhancement information (SEI) message. A DSC SEI message may include at least one of a digitally signed content initialization (DSCI) SEI message, a digitally signed content selection (DSCS) SEI message or a digitally signed content verification (DSCV) SEI message. It may provide a mechanism for verifying that a content provider who verifies his/her identity through a digital certificate referenced in a digitally signed content initialization SEI message generated a corresponding encoded image.

This SEI message may provide information for a secure hash algorithm used to calculate a message digest. A message digest may be used to verify the reliability of non-VCL NAL units having an NAL unit type identifier corresponding to values included in a list (non VclDigitallySignedNalUnitsList) and VCL NAL units included in an encoded video sequence along with a digital signature existing in a digitally signed content verification SEI message. Non VclDigitallySignedNalUnitsList may be a list constructed with non-VCL NAL unit type identifiers. As an example, non VclDigitallySignedNalUnitsList may consist of NAL unit types having nal_unit_type whose value is 15, 16, 17, 18 and 19.

This SEI message may provide information for a used digital signature algorithm and the public key of a content provider. A DSCI SEI message may provide the public key of a content provider by providing a URI that identifies a trust record including the certificate of a content provider or by providing a URI that directly identifies a certificate, as stipulated in ISO/IEC 21617-1.

When a DSCI SEI message exists in a random access unit (AU) within a coded video sequence (CVS), a DSCI SEI message shall exist for all IDR, CRA and GDR PUs of a corresponding CVS.

When a DSCI SEI message exists in a random AU within a CVS, it shall precede all non-VCL NAL units having an NAL unit type identifier corresponding to values included in non VclDigitallySignedNalUnitsList and all VCL NAL units of a corresponding AU.

Until one or more of the following conditions become true, a DSCI SEI message may be applied to a currently encoded picture and all subsequent encoded pictures.
A bitstream ends.
A new CVS starts.
A new DSCI SEI message is received.

When a DSCI SEI message exists in an AU within a CVS, a DSCV SEI message shall exist for each substream to which an NAL unit is assigned. A DSCV SEI message shall exist within a bitstream before one or more of the following conditions become true.
A bitstream ends.
A new CVS starts.
A new DSCI SEI message is received.

Table 1 is an example of a DSCI SEI message according to the present disclosure.

TABLE 1

| | Descriptor |
|---|---|
| digitally_signed_content_initialization( payloadSize ) { | |
| dsci_hash_method_type | u(8) |
| dsci_key_source_uri | st(v) |
| dsci_num_verification_substreams_minus1 | ue(v) |
| dsci_key_retrieval_mode_idc | ue(v) |
| if( dsci_key_retrieval_mode_idc== 1){ | |
| dsci_use_key_register_idx_flag | u(1) |
| if( dsci_use_key_register_idx_flag ) | |
| dsci_key_register_idx | ue(v) |
| } | |
| dsci_content_uuid_present_flag | u(1) |
| if( dsci_content_uuid_present_flag) | |
| dsci_content_uuid | u(128) |
| } | |

A DSCI SEI message may include hash method type information (dsci_hash_method_type).

dsci_hash_method_type may represent a secure hash algorithm used to calculate a message digest for subsets of non-VCL NAL units having an NAL unit type identifier corresponding to values included in non VclDigitallySignedNalUnitsList and VCL NAL units of an encoded video sequence.

Based on the message digest and a digital signature, a decoding apparatus may verify that a corresponding encoded video was generated by a content originator. The digital signature may exist in a DSCV SEI message. The content originator may be indicated by a syntax element (e.g., at least one of dsci_key_source_uri, dsci_use_key_register_idx_flag or dsci_key_register_idx). Syntax elements above will be described later.

A value supported for dsci_hash_method_type, a block size used to calculate a message digest and the size of a calculated message digest may be defined as shown in Table 2 below.

TABLE 2

| dsci_hash_meth- | | Block | Message digest |
|---|---|---|---|
| od_type | Hash method | size (bits) | size (bits) |
| 0 | SHA-1 | 512 | 160 |
| 1 | SHA-224 | 512 | 224 |
| 2 | SHA-256 | 512 | 256 |
| 3 | SHA-384 | 1024 | 384 |
| 4 | SHA-512 | 1024 | 512 |
| 5 | SHA-512/224 | 1024 | 224 |
| 6 | SHA-512/256 | 1024 | 256 |

Secure hash algorithms listed in Table 2 are stipulated in the “Secure Hash Standard” of NIST FIPS PUB 180-4.

A DSCI SEI message may include key source URI information (dsci_key_source_uri).

dsci_key_source_uri may include a uniform resource identifier (URI) that follows a syntax and semantics stipulated in IETF Internet Standard 66.

When dsci_key_retrieval_mode_idc to be described below is 0, dsci_key_source_uri may specify a trust record stipulated in ISO/IEC 21617-1. When dsci_key_retrieval_mode_idc is 1, the following may be applied:
When dsci_use_key_register_idx_flag is 0, a corresponding URI may identify the certificate of a content provider that may be used to verify a signature existing in subsequent DSCV SEI messages.
When dsci_use_key_register_idx_flag is 1, a corresponding URI may identify a certificate register and may identify the certificate of a content provider indicated by dsci_key_register_idx. A corresponding certificate may be used to verify a signature existing in subsequent DSCV SEI messages.

A DSCI SEI message may include substream number information (dsci_num_verification_substreams_minus1). dsci_num_verification_substreams_minus1 may represent the number of substreams where a message digest may be calculated and a signature may exist in subsequent DSCV SEI messages. As an example, the number of substreams (Num VerificationSubstream) may be derived as shown in Equation 1 below.

Num VerificationSubstream=dsci_num_verification_substreams_minus1+1 [Equation 1]

dsci_num_verification_substreams_minus1 may be encoded as a descriptor of ue(v). In other words, dsci_num_verification_substreams_minus1 may be a syntax element of a variable length that encodes an unsigned integer with an Exp-Golomb code.

A DSCI SEI message may include a key retrieval mode indicator (dsci_key_retrieval_mode_idc).

When dsci_key_retrieval_mode_idc is 0, it may represent that a URI included in dsci_key_source_uri specifies a trust record stipulated in ISO/IEC 21617-1. When dsci_key_retrieval_mode_idc is 1, it may represent that a URI included in dsci_key_source_uri and dsci_key_register_idx specify a certificate.

The value of dsci_key_retrieval_mode_idc shall fall within the range of 0 to 1. A decoding apparatus shall allow a different value of dsci_key_retrieval_mode_idc, but in this case, it shall ignore the contents of a DSCI SEI message, a related DSCS SEI message and a related DSCV SEI message.

A DSCI SEI message may include a register index flag (dsci_use_key_register_idx_flag).

When dsci_use_key_register_idx_flag is 1, it may represent that a URI included in dsci_key_source_uri specifies a certificate register. In addition, when dsci_use_key_register_idx_flag is 1, it may represent that dsci_key_register_idx exists in a DSCI SEI message. When dsci_use_key_register_idx_flag is 0, it may represent that a URI included in dsci_key_source_uri specifies a certificate. In addition, when dsci_use_key_register_idx_flag is 0, it may represent that dsci_key_register_idx does not exist in a DSCI SEI message.

When dsci_key_retrieval_mode_idc is 0, a media asset where the last trust manifest within a trust record stipulated in ISO/IEC 21617-1 provides content binding is a DSCI SEI message. The following restrictions may be applied to a trust record stipulated in ISO/IEC 21617-1 identified by dsci_key_source_uri:
The last trust manifest of a trust record stipulated in ISO/IEC 21617-1 shall include only one hard binding data hash assertion labeled c2pa.hash.data.
The schema of data hash assertion is defined by a data-hash-map rule included in the CDDL definition in Table 3 below.

```
TABLE 3
; The data structure used to store the cryptographic hash of some or all of the asset's data
; and additional information required to compute the hash.
data-hash-map = {
  ? “exclusions”: [1* EXCLUSION_RANGE-map], ; Ranges have monotonically increas
ing ′start′ values, and no two ranges may overlap.
  ? “alg”:tstr .size (1..max-tstr-length), ; A string identifying the cryptographic hash algor
ithm used to compute the hash in this assertion.
  “hash”: bstr, ; byte string of the hash value
  “pad”: bstr, ; zero-filled byte string used for filling up space
  ? “pad2”: bstr, ; optional zero-filled byte string used for filling up space
  ? “name”: tstr .size (1..max-tstr-length), ; (optional) a human-readable description of w
hat this hash cover
  ? “url”: uri, ; Unused and deprecated.
}
EXCLUSION_RANGE-map = {
  “start”: int, ; Starting byte of the range
  “length”: int, ; Number of bytes of data to exclude
}
```

An exclusion range that specifies data excluded when calculating a hash value in a DSCI SEI message and is indicated in data hash assertion shall match a dsci_key_source_uri byte within a DSCI SEI message.

dsci_use_key_register_idx_flag may be adaptively signaled based on dsci_key_retrieval_mode_idc. As an example, dsci_use_key_register_idx_flag may be signaled based on the value of dsci_key_retrieval_mode_idc being 1. dsci_use_key_register_idx_flag may not be signaled based on the value of dsci_key_retrieval_mode_idc being 0.

A DSCI SEI message may include register index information (dsci_key_register_idx).

dsci_key_register_idx may include an index that specifies the certificate of a content provider within a certificate register indicated by dsci_key_source_uri. The certificate of the content provider may be used to verify a signature existing in subsequent DSCV SEI messages.

A certificate indicated by at least one of dsci_key_retrieval_mode_idc, dsci_use_key_register_idx_flag, dsci_key_source_uri or dsci_key_register_idx is required to specify at least one of a digital signature method or the public key of a content provider.

dsci_key_register_idx may be adaptively signaled based on dsci_use_key_register_idx_flag. As an example, dsci_key_register_idx may be signaled based on the value of dsci_use_key_register_idx_flag being 1. dsci_key_register_idx may not be signaled based on the value of dsci_use_key_register_idx_flag being 0.

dsci_key_register_idx may be adaptively signaled based on dsci_key_retrieval_mode_idc. As an example, dsci_key_register_idx may be signaled based on the value of dsci_key_retrieval_mode_idc being 1. dsci_key_register_idx may not be signaled based on the value of dsci_key_retrieval_mode_idc being 0.

A DSCI SEI message may include a UUID presence flag (dsci_content_uuid_present_flag).

When dsci_content_uuid_present_flag is 1, it may represent that dsci_content_uuid exists. When dsci_content_uuid_present_flag is 0, it may represent that dsci_content_uuid does not exist.

When dsci_key_retrieval_mode_idc is 0, dsci_content_uuid_present_flag may be restricted to have a value of 1.

A DSCI SEI message may include content UUID information (dsci_content_uuid). dsci_content_uuid may represent an identifier for video content. dsci_content_uuid shall have a value specified as a UUID according to the procedures of Appendix A of ISO/IEC 11578:1996.

When a DSCI SEI message exists within an AU, the calculation of Num VerificationSubstream message digests may be initialized according to the regulations of NIST FIPS PUB 180-4 for dsci_hash_method_type. Each of the VCL NAL units and non-VCL NAL units having an NAL unit type identifier corresponding to values within Non VclDigitallySignedNalUnitsList may be associated with one of the Num VerificationSubstream message digests. Here, at least one of the non-VCL NAL units or VCL NAL units may follow a DSCI SEI message. A verification substream ID may be indicated by a DSCS SEI message. Alternatively, when a DSCS SEI message does not exist for a specific picture unit (PU), a verification substream ID may be inferred as 0.

A message for calculating the k-th message digest may be obtained by concatenating all non-VCL NAL units having an NAL unit type identifier corresponding to values within non VclDigitallySignedNalUnitsList and VCL NAL units associated with the k-th verification substream. k may fall within the range of 0 to dsci_num_verification_substreams_minus1.

The calculation of a message digest may be performed based on a block. Here, a block size may be defined as shown in Table 2 according to dsci_hash_method_type.

For each of the VCL NAL units and non-VCL NAL units having an NAL unit type identifier corresponding to values within non VclDigitallySignedNalUnitsList, a corresponding message digest may be updated according to an algorithm specified in NIST FIPS PUB 180-4 for specified dsci_hash_method_type. Since a message digest is calculated for the concatenation of a non-VCL NAL unit and a VCL NAL unit for a verification substream, a processing block is generally processed by being partitioned across two or more consecutive NAL units.

A DSCS SEI message may provide a mechanism for associating an encoded picture with one of the verification substreams indicated in a DSCI SEI message.

When an AU includes both a DSCI SEI message and a DSCS SEI message, a DSCI SEI message shall precede a DSCS SEI message in decoding order.

When a CVS does not include a DSCI SEI message, the coded layer video sequence (CLVS) of a corresponding CVS shall not include a DSCS SEI message.

When a DSCS SEI message exists in the AU of a CVS, it shall precede all non-VCL NAL units having an NAL unit type identifier corresponding to values within non VclDigitallySignedNalUnitsList and all VCL NAL units of an AU in decoding order.

Table 4 is an example of a DSCS SEI message according to the present disclosure.

TABLE 4

| | Descriptor |
|---|---|
| digitally_signed_content_selection( payloadSize ) { | |
| dscs_verification_substream_id | u(8) |
| } | |

A DSCS SEI message may include a substream identifier (dscs_verification_substream_id).

dscs_verification_substream_id may represent a verification substream to which VCL NAL units and non-VCL NAL units having an NAL unit type identifier corresponding to values within non VclDigitallySignedNalUnitsList of a currently encoded picture are assigned.

When a DSCI SEI message exists in a currently encoded video sequence but a DSCI SEI message for an encoded picture does not exist, the value of dscs_verification_substream_id may be inferred as 0. The value of dscs_verification_substream_id shall be within the range of 0 to dsci_num_verification_substreams_minus1.

The message digest of a verification substream corresponding to dscs_verification_substream_id may be updated based on VCL NAL units and non-VCL

NAL units having an NAL unit type identifier corresponding to values within non VclDigitallySignedNalUnitsList of a currently encoded picture according to dsci_hash_method_type specified in a previous DSCI SEI message.

dscs_verification_substream_id may be encoded as a descriptor of u(8). In other words, dscs_verification_substream_id may be an 8-bit syntax element that encodes an unsigned integer.

A DSCV SEI message may provide a mechanism for verifying the digital signature of video content.

When a CVS does not include a DSCI SEI message, the CLVS of a corresponding CVS shall not include a DSCV SEI message.

When an AU includes both a DSCI SEI message and a DSCV SEI message, a DSCI

SEI message shall precede a DSCV SEI message. When a PU includes both a DSCS SEI message and a DSCV SEI message, a DSCS SEI message shall precede a DSCV SEI message.

When a DSCV SEI message exists in the PU of a CVS, VCL NAL units and/or nonVCL NAL units (having an NAL unit type identifier corresponding to values within non VclDigitallySignedNalUnitsList) may not be assigned to a substream indicated by dscv_verification_substream_id unless one or more of the following conditions are true.
A bitstream ends.
A new CVS starts.
A new DSCI SEI message is received.

Table 5 is an example of a DSCV SEI message according to the present disclosure.

TABLE 5

| | Descriptor |
|---|---|
| digitally_signed_content_verification( payloadSize ) { | |
| dscv_verification_substream_id | u(8) |
| dscv_signature_length_in_octets_minus1 | u(16) |
| dscv_signature | u(v) |
| } | |

A DSCV SEI message may include a substream identifier (dscv_verification_substream_id). dscv_verification_substream_id may represent a verification substream to which a corresponding SEI message is applied.

A DSCV SEI message may include signature length information (dscv_signature_length_in_octets_minus1). A value obtained by adding 1 to dscv_signature_length_in_octets_minus1 may specify the length of dscv_signature in an octet unit (1 octet=8 bits).

A DSCV SEI message may include signature information (dscv_signature). dscv_signature may include a digital signature for a verification substream indicated by dscv_verification_substream_id.

The verification of a bitstream signature according to the present disclosure may be configured in the following order.
1. The calculation of a message digest (CurrDigest) is completed as follows:
   For a verification substream with the same ID as dscv_verification_substream_id, the concatenation of VCL NAL units and non-VCL NAL units having an NAL unit type identifier corresponding to values within non VclDigitallySignedNalUnitsList is padded according to the standards of NIST FIPS PUB 180-4.
   The calculation of a message digest (CurrDigest) is completed according to the standards of NIST FIPS PUB 180-4.
2. A reference message digest (RefDigest) is determined as follows:
   When dscv_verification_substream_id is greater than 0, a reference message digest (RefDigest) is a message digest that is lastly calculated for a verification substream with the same ID as (dscv_verification_substream_id−1). A DSCV SEI message corresponding to (dscv_verification_substream_id−1) shall exist prior to a DSCV SEI message corresponding to dscv_verification_substream_id.
   Otherwise, when a current DSCV SEI message is the first DSCV SEI message with the verification ID of 0 in an encoded video sequence and a previous encoded video sequence does not include a DSCI SEI message (which includes a case in which a current encoded video sequence is the first encoded video sequence within a bitstream), RefDigest is set as a bitstring consisting of DigestSize bits equal to 1. Here, DigestSize may refer to the size of a message digest.
   Otherwise, a reference message digest (RefDigest) is a message digest that is lastly calculated for a verification substream with the same ID as 0.
3. An identification string (IdString) may be configured by concatenating the binary expression of at least one of a reference message digest (RefDigest), a current message digest (CurrDigest), dsci_hash_method_type or dsci_content_uuid.

The number of bits in RefDigest may be determined by a dsci_hash_method_type value that was valid when calculating an RefDigest value. The number of bits in CurrDigest may be determined by the current value of dsci_hash_method_type. The value of dsci_hash_method_type may be expressed in 8 bits. The value of dsci_content_uuid may be expressed in 128 bits.
4. An identification string (IdString) may represent a message used to verify a signature. A signature verification algorithm and a public key used for signature verification may be indicated based on at least one of dsci_use_key_register_idx_flag, dsci_key_source_uri or dsci_key_register_idx.

Since RefDigest is included in a bitstring used for signature verification, it is possible to additionally verify whether VCL NAL units and nonVCL NAL units used to calculate a current message digest are correct, whether additional nonVCL NAL units or VCL NAL units are inserted into a bitstream or whether non VCL NAL units or VCL NAL units are removed from a bitstream.

When a decoding apparatus accesses a bitstream, IdString configured for the first DSCV SEI message may not be verified. It is because the value of RefDigest may not be calculated correctly. However, starting from the second DSCV SEI message, a signature may be verified.

After verification is completed, a message digest for a verification substream corresponding to dscv_verification_substream_id may be re-initialized according to the NIST FIPS PUB 180-4 standards according to specified dsci_hash_method_type.

As described above, a digitally signed content SEI message may consist of three types. In other words, a digitally signed content SEI message may consist of a DSCI SEI message for setting a verification context for a CVS, a DSCS SEI message for assigning an NAL unit to a verification substream and a DSCV SEI message for verifying substream integrity by using a current message digest and a reference message digest.

The semantics of a current DSCI SEI message specifies that an SEI message may exist at a designated location within an AU. However, although it is clear that only one SEI message within an AU is available to perform a desired function, it is not clearly stipulated how many DSCI SEI messages may exist within an AU. Accordingly, the present disclosure proposes various embodiments to solve the above-described problem. The following embodiments may be applied individually or in combination of at least two.

### Embodiment 1

When there are two or more DSCI SEI messages within one AU, a constraint ensuring that all DSCI SEI messages have the same content may be added. In other words, all DSCI SEI messages belonging to one AU may be restricted to having the same content.

### Embodiment 2

A constraint ensuring that up to only one DSCI SEI message exists within one AU may be added. In other words, the maximum number of DSCI SEI messages that can be included in one AU may be restricted to 1.

### Embodiment 3

At least one of the first constraint that a DSCI SEI message shall exist in a coded video sequence start (CVSS) access unit (AU) or the second constraint that when there are two or more DSCI SEI messages within a coded video sequence (CVS), all DSCI SEI messages shall have the same content may be added.

Specifically, when a DSCI SEI message exists in a random AU within a CVS, a DSCI SEI message shall exist for a CVSS AU.

When a DSCI SEI message exists in a random AU within a CVS, it shall precede all non-VCL NAL units having an NAL unit type identifier corresponding to values included in non VclDigitallySignedNalUnitsList and all VCL NAL units of a corresponding AU. In this case, all DSCI SEI messages applied to the same CVS shall have the same content.

When a DSCI SEI message exists in an AU within a CVS, a DSCV SEI message shall exist within a CVS for each substream to which an NAL unit is assigned.

### Embodiment 4

To represent that the persistence scope of a DSCI SEI message is specified by the semantics of an SEI message, an item may be added to a table for the persistence scope of an SEI message.

As an example, the persistence scope of an SEI message may be defined as shown in Table 6 below. As defined in Table 6, the persistence scope of a DSCI SEI message may be specified by the semantics of a corresponding SEI message.

TABLE 6

| SEI message | Persistence scope |
|---|---|
| Filler payload | The PU containing the SEI message |
| User data registered by Rec. | Unspecified |
| ITU-T T.35 | |
| User data unregistered | Unspecified |
| Film grain characteristics | Specified by the syntax of the SEI message |
| Frame packing arrangement | Specified by the syntax of the SEI message |
| Parameter sets inclusion | The CLVS containing the SEI message |
| indication | |
| Decoded picture hash | The PU containing the SEI message |
| Mastering display colour volume | The CLVS containing the SEI message |
| Content light level information | The CLVS containing the SEI message |
| DRAP indication | The picture associated with the SEI message |
| Alternative transfer | The CLVS containing the SEI message |
| characteristics | |
| Ambient viewing environment | The CLVS containing the SEI message |
| Content colour volume | Specified by the syntax of the SEI message |
| Equirectangular projection | Specified by the syntax of the SEI message |
| Generalized cubemap projection | Specified by the syntax of the SEI message |
| Sphere rotation | Specified by the syntax of the SEI message |
| Region-wise packing | Specified by the syntax of the SEI message |
| Omnidirectional viewport | Specified by the syntax of the SEI message |
| Frame-field information | The PU containing the SEI message |
| Sample aspect ratio information | Specified by the syntax of the SEI message |
| Annotated regions | Specified by the syntax of the SEI message |
| Scalability dimension | The CVS containing the SEI message |
| information | |
| Multiview acquisition | The CVS containing the SEI message |
| information | |
| Multiview view position | The CVS containing the SEI message |
| Depth representation information | Specified by the semantics of the SEI message |
| Alpha channel information | Specified by the syntax of the SEI message |
| Extended DRAP indication | The picture associated with the SEI message |
| Display orientation | Specified by the syntax of the SEI message |
| Colour transform information | Specified by the syntax of the SEI message |
| Shutter interval information | The CLVS containing the SEI message |
| Neural-network post-filter | The CLVS containing the SEI message |
| characteristics | |
| Neural-network post-filter | Specified by the syntax of the SEI message |
| activation | |
| Phase indication | Specified by the semantics of the SEI message |
| SEI processing order | For each value of po_id, the number of SEI |
| | messages and the payloadType codes of the |
| | SEI messages indicated within the SEI |
| | processing order SEI message persist for the |
| | CVS containing the SEI processing order SEI |
| | message. |
| Processing order nesting | Depending on the processing-order-nested SEI |
| | messages. Each processing-order-nested SEI |
| | message has the same persistence scope as if |
| | the SEI message was not nested. |
| Encoder optimization | Specified by the syntax of the SEI message |
| information | |
| Source picture timing | Specified by the syntax of the SEI message |
| information | |
| Object mask information | Specified by the syntax of the SEI message |
| Modality information | Specified by the syntax of the SEI message |
| Text descriptions | Specified by the syntax of the SEI message |
| Digitally signed content | Specified by the semantics of the SEI message |
| initialization | |

### Embodiment 5

To represent that the persistence scope of a DSCI SEI message is a CVS including an SEI message, an item may be added to a table for the persistence scope of an SEI message.

As an example, the persistence scope of an SEI message may be defined as shown in Table 7 below. As defined in Table 7, the persistence scope of a DSCI SEI message may be a CVS including a corresponding SEI message.

TABLE 7

| SEI message | Persistence scope |
|---|---|
| Filler payload | The PU containing the SEI message |
| User data registered by Rec. | Unspecified |
| ITU-T T.35 | |
| User data unregistered | Unspecified |
| Film grain characteristics | Specified by the syntax of the SEI message |
| Frame packing arrangement | Specified by the syntax of the SEI message |
| Parameter sets inclusion | The CLVS containing the SEI message |
| indication | |
| Decoded picture hash | The PU containing the SEI message |
| Mastering display colour volume | The CLVS containing the SEI message |
| Content light level information | The CLVS containing the SEI message |
| DRAP indication | The picture associated with the SEI message |
| Alternative transfer | The CLVS containing the SEI message |
| characteristics | |
| Ambient viewing environment | The CLVS containing the SEI message |
| Content colour volume | Specified by the syntax of the SEI message |
| Equirectangular projection | Specified by the syntax of the SEI message |
| Generalized cubemap projection | Specified by the syntax of the SEI message |
| Sphere rotation | Specified by the syntax of the SEI message |
| Region-wise packing | Specified by the syntax of the SEI message |
| Omnidirectional viewport | Specified by the syntax of the SEI message |
| Frame-field information | The PU containing the SEI message |
| Sample aspect ratio information | Specified by the syntax of the SEI message |
| Annotated regions | Specified by the syntax of the SEI message |
| Scalability dimension | The CVS containing the SEI message |
| information | |
| Multiview acquisition | The CVS containing the SEI message |
| information | |
| Multiview view position | The CVS containing the SEI message |
| Depth representation information | Specified by the semantics of the SEI message |
| Alpha channel information | Specified by the syntax of the SEI message |
| Extended DRAP indication | The picture associated with the SEI message |
| Display orientation | Specified by the syntax of the SEI message |
| Colour transform information | Specified by the syntax of the SEI message |
| Shutter interval information | The CLVS containing the SEI message |
| Neural-network post-filter | The CLVS containing the SEI message |
| characteristics | |
| Neural-network post-filter | Specified by the syntax of the SEI message |
| activation | |
| Phase indication | Specified by the semantics of the SEI message |
| SEI processing order | For each value of po_id, the number of SEI |
| | messages and the payloadType codes of the |
| | SEI messages indicated within the SEI |
| | processing order SEI message persist for the |
| | CVS containing the SEI processing order SEI |
| | message. |
| Processing order nesting | Depending on the processing-order-nested SEI |
| | messages. Each processing-order-nested SEI |
| | message has the same persistence scope as if |
| | the SEI message was not nested. |
| Encoder optimization | Specified by the syntax of the SEI message |
| information | |
| Source picture timing | Specified by the syntax of the SEI message |
| information | |
| Object mask information | Specified by the syntax of the SEI message |
| Modality information | Specified by the syntax of the SEI message |
| Text descriptions | Specified by the syntax of the SEI message |
| Digitally signed content | The CVS containing the SEI message |
| initialization | |

### Embodiment 6

A constraint ensuring that a DSCI SEI message exists in an instantaneous random access point (IRAP) AU or a gradual decoder refresh (GDR) AU and all DSCI SEI messages within an AU other than an IRAP AU or a GDR AU have the same content as a DSCI SEI message existing in the last IRAP AU or GDR AU may be added.

Specifically, when a DSCI SEI message exists in a random access unit (AU) within a coded video sequence (CVS), a DSCI SEI message shall exist for all IRAP AUs and GDR AUs within a corresponding CVS.

All DSCI SEI messages existing in an AU other than an IRAP AU or a GDR AU may be restricted to have the same content as a DSCI SEI message existing in the last IRAP AU or GDR AU.

When a DSCI SEI message exists in a random AU within a CVS, it shall precede all non-VCL NAL units having an NAL unit type identifier corresponding to values included in non VclDigitallySignedNalUnitsList and all VCL NAL units of a corresponding AU.

### Embodiment 7

A constraint ensuring that a DSCI SEI message exists in an IRAP PU or a GDR PU and all DSCI SEI messages within a PU other than an IRAP PU or a GDR PU have the same content as a DSCI SEI message existing in the last IRAP PU or GDR PU may be added.

Specifically, when a DSCI SEI message exists in a random picture unit (PU) within a coded layer video sequence (CLVS), a DSCI SEI message shall exist for all IDR, CRA and GDR PUs of a corresponding CLVS.

All DSCI SEI messages existing in a PU other than an IRAP PU or a GDR PU may be restricted to have the same content as a DSCI SEI message existing in the last IRAP PU or GDR PU.

When a DSCI SEI message exists in a random AU within a CVS, it shall precede all non-VCL NAL units having an NAL unit type identifier corresponding to values included in non VclDigitallySignedNalUnitsList and all VCL NAL units of a corresponding AU.

The semantics of a current DSCI SEI message specifies that a corresponding SEI message exists in an AU, but it is not clearly stipulated how many DSCI SEI messages may exist in one AU and how to process a case in which two or more DSCI SEI messages exist.

In addition, current semantics specifies that the first DSCV SEI message of a bitstream shall have dscv_verification_substream_id of 0 and a verification substream with dscv_verification_substream_id of 0 does not refer to a previous verification substream. However, it is not clearly stipulated whether a DSCV SEI message that is not the first DSCV SEI message within a bitstream but appears first after a DSCI SEI message also shall have dscv_verification_substream_id of 0.

Since an identifier for these SEI messages may be added to support the DSCI, DSCS and DSCV SEI messages of a multi-instance, this aspect also needs to be considered.

Accordingly, the present disclosure proposes various embodiments to solve the above-described problem. The following embodiments may be applied individually or in combination of at least two.

### Embodiment 1

A restriction may be added that up to one DSCI SEI message with a specific identifier shall exist in one AU.

Specifically, when a DSCI SEI message exists in a random access unit (AU) within a coded video sequence (CVS), a DSCI SEI message shall exist for all IDR, CRA and GDR PUs of a corresponding CVS.

When a DSCI SEI message exists in a random AU within a CVS, it shall precede all non-VCL NAL units having an NAL unit type identifier corresponding to values included in non VclDigitallySignedNalUnitsList and all VCL NAL units of a corresponding AU.

A DSCI SEI message with the DSCI identifier (dsci_id) of a specific value may be restricted such that at most one is included in one AU. Here, a DSCI identifier may be information for identifying a DSCI SEI message. A DSCI identifier may specify one of a plurality of DSCI SEI messages.

### Embodiment 2

A restriction for clarifying whether a DSCV SEI message appearing first after a DSCI SEI message shall have a substream identifier with a value of 0 (dscv_verification_substream_id) may be added.

Specifically, scv_verification_substream_id may be included in a DSCV SEI message. dscv_verification_substream_id may represent a verification substream to which a corresponding DSCV SEI message is applied.

The first DSCV SEI message having a specific DSCV identifier that follows a DSCI SEI message having a DSCI identifier (dsci_id) with the same value as the specific DSCV identifier (dscv_id) in decoding order may be restricted to have dscv_verification_substream_id with a value of 0.

Here, a DSCV identifier may be information for identifying a DSCV SEI message. A DSCV identifier may specify one of a plurality of DSCV SEI messages. A DSCI identifier may be information for identifying a DSCI SEI message. A DSCI identifier may specify one of a plurality of DSCI SEI messages.

In other words, within a verification period for a DSCI identifier (dsci_id) with the same value as a specific DSCV identifier (dscv_id), dscv_verification_substream_id for the first DSCV SEI message having the specific DSCV identifier in decoding order may be restricted to have a value of 0.

Here, a verification period may refer to a period from a DSCI SEI message having a specific DSCI identifier to a DSCI SEI message having a DSCI identifier with the same value as the specific DSCI identifier. A verification period for a DSCI identifier may include a DSCI SEI message having a corresponding DSCI identifier and one or more DSCV SEI messages having a DSCV identifier with the same value as a corresponding DSCI identifier. In this case, within a verification period, one or more DSCV SEI messages may exist after a DSCI SEI message.

When a new DSCI SEI message is applied, a new value space may be used for dscs_verification_substream_id and dscv_verification_substream_id.

A DSC SEI message according to the present disclosure may be included in the network abstraction layer (NAL) unit of a bitstream. Alternatively, information defined in a DSC SEI message according to the present disclosure may also be configured in the high-level syntax of a bitstream. Here, a high-level syntax may be at least one of a sequence parameter set (SPS), a picture parameter set (PPS), a picture header (PH) or a slice header (SH). Alternatively, a DSC SEI message according to the present disclosure may also be defined as a separate NAL unit type within a bitstream.

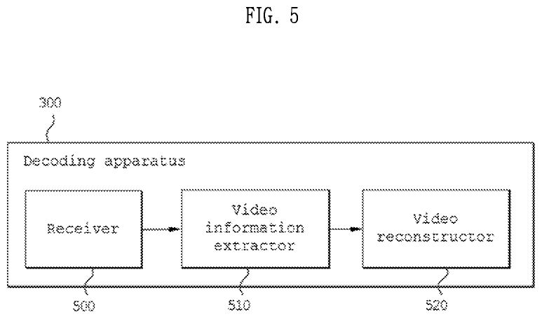

FIG. 5 illustrates a schematic configuration of the decoding apparatus 300 that performs a method for reconstructing a video picture according to the present disclosure.

Referring to FIG. 5, the decoding apparatus 300 may include the receiver 500, the video information extractor 510 and the video reconstructor 520.

The receiver 500 may receive a bitstream including an encoded video picture.

The video information extractor 510 may extract video information related to an encoded video picture from a bitstream. In addition, the video information extractor 710 may extract a DSC SEI message from a bitstream, which is the same as described by referring to FIG. 4.

The video reconstructor 520 may reconstruct an encoded video picture based on extracted video information.

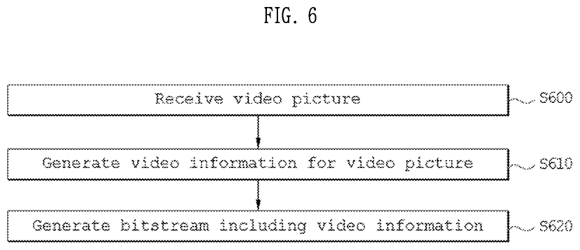

FIG. 6 illustrates a method for generating a bitstream performed by the encoding apparatus 200 according to the present disclosure.

A video picture to be encoded may be received S600.

A received video picture may be encoded to generate video information related to a video picture S610.

A bitstream including video information related to a video picture may be generated S420.

In addition, a DSC SEI message applied to a bitstream may be generated, which is the same as described by referring to FIG. 4. The generated DSC SEI message may be included in a bitstream. Alternatively, information defined in a DSC SEI message may also be configured in the high-level syntax of a bitstream.

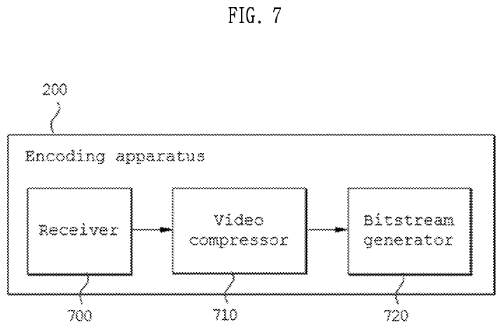

FIG. 7 illustrates a schematic configuration of the encoding apparatus 200 that performs a method for generating a bitstream according to the present disclosure.

Referring to FIG. 7, the encoding apparatus 200 may include the receiver 700, the video compressor 710 and the bitstream generator 720.

The receiver 700 may receive one or more video pictures to be encoded.

The video compressor 710 may encode one or more received video pictures to generate video information related to a video picture. The video compressor 710 may generate a DSC SEI message applied to a bitstream.

The bitstream generator 720 may generate a bitstream including the video information. The bitstream generator 720 may generate a bitstream further including the generated DSC SEI message.

In the above-described embodiment, methods are described based on a flowchart as a series of steps or blocks, but a corresponding embodiment is not limited to the order of steps, and some steps may occur simultaneously or in different order with other steps as described above. In addition, those skilled in the art may understand that steps shown in a flowchart are not exclusive, and that other steps may be included or one or more steps in a flowchart may be deleted without affecting the scope of embodiments of the present disclosure.

The above-described method according to embodiments of the present disclosure may be implemented in a form of software, and an encoding apparatus and/or a decoding apparatus according to the present disclosure may be included in a device which performs image processing such as a TV, a computer, a smartphone, a set top box, a display device, etc.

In the present disclosure, when embodiments are implemented as software, the above-described method may be implemented as a module (a process, a function, etc.) that performs the above-described function. A module may be stored in a memory and may be executed by a processor. A memory may be internal or external to a processor, and may be connected to a processor by a variety of well-known means. A processor may include an application-specific integrated circuit (ASIC), another chipset, a logic circuit and/or a data processing device. A memory may include a read-only memory (ROM), a random access memory (RAM), a flash memory, a memory card, a storage medium and/or another storage device. In other words, embodiments described herein may be performed by being implemented on a processor, a microprocessor, a controller or a chip. For example, functional units shown in each drawing may be performed by being implemented on a computer, a processor, a microprocessor, a controller or a chip. In this case, information for implementation (ex. information on instructions) or an algorithm may be stored in a digital storage medium.

In addition, a decoding apparatus and an encoding apparatus to which embodiment(s) of the present disclosure are applied may be included in a multimedia broadcasting transmission and reception device, a mobile communication terminal, a home cinema video device, a digital cinema video device, a surveillance camera, a video conversation device, a real-time communication device like a video communication, a mobile streaming device, a storage medium, a camcorder, a device for providing video on demand (VOD) service, an over the top video (OTT) device, a device for providing Internet streaming service, a three-dimensional (3D) video device, a virtual reality (VR) device, an argumente reality (AR) device, a video phone video device, a transportation terminal (ex. a vehicle (including an autonomous vehicle) terminal, an airplane terminal, a ship terminal, etc.) and a medical video device, etc., and may be used to process a video signal or a data signal. For example, an over the top video (OTT) device may include a game console, a blu-ray player, an Internet-connected TV, a home theater system, a smartphone, a tablet PC, a digital video recorder (DVR), etc.

In addition, a processing method to which embodiment(s) of the present disclosure are applied may be produced in a form of a program executed by a computer and may be stored in a computer-readable recording medium. Multimedia data having a data structure according to embodiment(s) of the present disclosure may be also stored in a computer-readable recording medium. The computer-readable recording medium includes all types of storage devices and distributed storage devices that store computer-readable data. The computer-readable recording medium may include, for example, a blu-ray disk (BD), an universal serial bus (USB), ROM, PROM, EPROM, EEPROM, RAM, CD-ROM, a magnetic tape, a floppy disk and an optical media storage device. In addition, the computer-readable recording medium includes media implemented in a form of a carrier wave (e.g., transmission via the Internet). In addition, a bitstream generated by an encoding method may be stored in a computer-readable recording medium or may be transmitted through a wired or wireless communication network.

In addition, embodiment(s) of the present disclosure may be implemented by a computer program product by a program code, and the program code may be executed on a computer by embodiment(s) of the present disclosure. The program code may be stored on a computer-readable carrier.

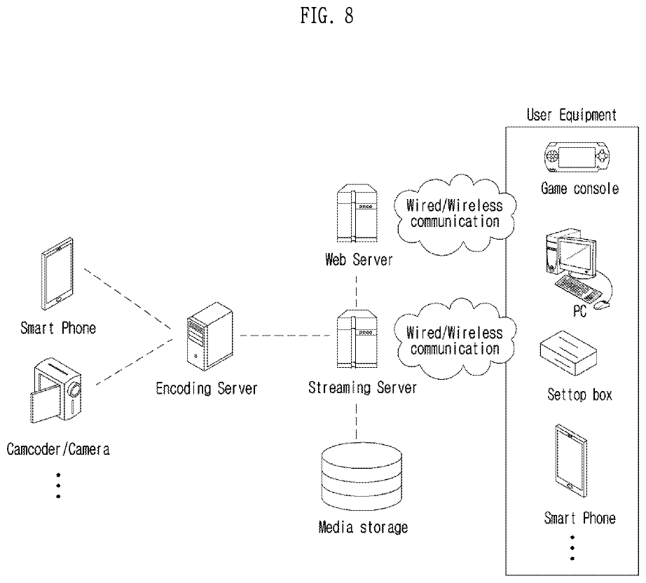

FIG. 8 shows an example of a contents streaming system to which embodiments of the present disclosure may be applied.

Referring to FIG. 8, a contents streaming system to which embodiment(s) of the present disclosure are applied may largely include an encoding server, a streaming server, a web server, a media storage, a user device and a multimedia input device.

The encoding server generates a bitstream by compressing contents input from multimedia input devices such as a smartphone, a camera, a camcorder, etc. into digital data and transmits it to the streaming server. As another example, when multimedia input devices such as a smartphone, a camera, a camcorder, etc. directly generate a bitstream, the encoding server may be omitted.

The bitstream may be generated by an encoding method or a bitstream generation method to which embodiment(s) of the present disclosure are applied, and the streaming server may temporarily store the bitstream in a process of transmitting or receiving the bitstream.

The streaming server transmits multimedia data to a user device based on a user's request through a web server, and the web server serves as a medium to inform a user of what service is available. When a user requests desired service from the web server, the web server delivers it to a streaming server, and the streaming server transmits multimedia data to a user. In this case, the contents streaming system may include a separate control server, and in this case, the control server controls a command/a response between each device in the content streaming system.

The streaming server may receive contents from a media storage and/or an encoding server. For example, when contents is received from the encoding server, the contents may be received in real time. In this case, in order to provide smooth streaming service, the streaming server may store the bitstream for a certain period of time.

An example of the user device may include a mobile phone, a smart phone, a laptop computer, a digital broadcasting terminal, a personal digital assistants (PDAs), a portable multimedia players (PMP), a navigation, a slate PC, a Tablet PC, an ultrabook, a wearable device (e.g., a smartwatch, a smart glass, a head mounted display (HMD), a digital TV, a desktop, a digital signage, etc.

Each server in the contents streaming system may be operated as a distributed server, and in this case, data received from each server may be distributed and processed.

The claims set forth herein may be combined in various ways. For example, a technical characteristic of a method claim of the present disclosure may be combined and implemented as a device, and a technical characteristic of a device claim of the present disclosure may be combined and implemented as a method. In addition, a technical characteristic of a method claim of the present disclosure and a technical characteristic of a device claim may be combined and implemented as a device, and a technical characteristic of a method claim of the present disclosure and a technical characteristic of a device claim may be combined and implemented as a method.

What is claimed is:

1. A method, comprising:
receiving a bitstream including an encoded video picture; and
reconstructing the encoded video picture included in the bitstream,
wherein the bitstream includes a digitally signed content (DSC) supplemental enhancement information (SEI) message,
wherein the DSC SEI message includes at least one of a digitally signed content initialization (DSCI) SEI message, a digitally signed content selection (DSCS) SEI message, or a digitally signed content verification (DSCV) SEI message, and
wherein the DSC SEI message is obtained from a network abstraction layer (NAL) unit of the bitstream.

2. The method of claim 1, wherein when two or more DSCI SEI messages exist in one access unit (AU), all DSCI SEI messages belonging to the one AU are restricted to have a same content.

3. The method of claim 1, wherein a maximum number of DSCI SEI messages that can be included in one access unit (AU) is restricted to 1.

4. The method of claim 1, wherein the DSCI SEI message is restricted to exist for a coded video sequence start (CVSS) access unit (AU) within a coded video sequence (CVS).

5. The method of claim 1, wherein all DSCI SEI messages applied to a same coded video sequence (CVS) are restricted to have a same content.

6. The method of claim 1, wherein when the DSCI SEI message exists in an access unit (AU) within a coded video sequence (CVS), the DSCV SEI message is restricted to exist within the CVS for each substream to which the NAL unit is assigned.

7. The method of claim 1, wherein a persistence scope of the DSCI SEI message is specified by semantics of the DSCI SEI message.

8. The method of claim 1, wherein a persistence scope of the DSCI SEI message is a coded video sequence (CVS) including the DSCI SEI message.

9. The method of claim 1, wherein all DSCI SEI messages existing in an access unit (AU) other than an instantaneous random access point (IRAP) AU or a gradual decoder refresh (GDR) AU are restricted to have a same content as a DSCI SEI message existing in a last IRAP AU or a last GDR AU.

10. The method of claim 1, wherein all DSCI SEI messages existing in a picture unit (PU) other than an instantaneous random access point (IRAP) PU or a gradual decoder refresh (GDR) PU are restricted to have a same content as a DSCI SEI message existing in a last IRAP PU or a last GDR PU.

11. The method of claim 1, wherein a DSCI SEI message having a DSCI identifier of a specific value is restricted such that at most one is included in one access unit (AU).

12. The method of claim 1, wherein the DSCV SEI message includes a substream identifier representing a verification substream to which the DSCV SEI message is applied, and
wherein a first DSCV SEI message having a specific DSCV identifier that follows a DSCI SEI message having a DSCI identifier of a same value as the specific DSCV identifier in a decoding order is restricted to have a substream identifier with a value of 0.

13. A method, comprising:
receiving a video picture to be encoded;
encoding the received video picture to generate video information related to the video picture;
generating a digitally signed content (DSC) supplemental enhancement information (SEI) message; and
generating a bitstream including the video information and the DSC SEI message,
wherein the DSC SEI message includes at least one of a digitally signed content initialization (DSCI) SEI message, a digitally signed content selection (DSCS) SEI message, or a digitally signed content verification (DSCV) SEI message, and
wherein the DSC SEI message is encoded into a network abstraction layer (NAL) unit of the bitstream.

14. A non-transitory computer-readable storage medium for storing a bitstream generated by the method according to claim 13.

15. A method, comprising:
generating a bitstream, wherein the bitstream is generated based on receiving a video picture to be encoded, encoding the received video picture to generate video information related to the video picture, and generating a digitally signed content (DSC) supplemental enhancement information (SEI) message; and
transmitting data including the bitstream,
wherein the DSC SEI message includes at least one of a digitally signed content initialization (DSCI) SEI message, a digitally signed content selection (DSCS) SEI message, or a digitally signed content verification (DSCV) SEI message, and
wherein the DSC SEI message is encoded into a network abstraction layer (NAL) unit of the bitstream.
